(19) United States
(12) Patent Application Publication
(10) Pub. No.: US 2017/0021598 A1
(43) Pub. Date: Jan. 26, 2017

(54) CONVENIENT FLOOR TILE

(71) Applicant: DONGGUAN MEI JER PLASTIC PRODUCTS CO., LTD., Dongguan (CN)

(72) Inventor: Ben-Yuan Chen, Dongguan (CN)

(21) Appl. No.: 14/804,352

(22) Filed: Jul. 21, 2015

(51) Int. Cl. B32B 27/08; C08K 3/26; B32B 27/18; C08K 5/12; B32B 27/30; B32B 27/22; C09J 127/06; C08K 5/101

(52) U.S. Cl. CPC B32B 27/08; C09J 127/06; C08K 3/26; C08K 5/101; C08K 5/12; B32B 27/304; B32B 27/22; B32B 27/18; B32B 2419/04; B32B 2264/102; B32B 2264/104

(57) ABSTRACT

A convenient floor tile comprises a convenient tiling layer, a base layer and a surface layer which are superimposed in sequence from bottom to top. A composition of the base layer includes PVC, a plasticizer, a stabilizer and an anti-precipitation agent. The anti-precipitation agent is made from CPE, PEG and an absorbent. The composition and material are calculated in parts by weight: 100 parts of PVC, 30-50 parts of the plasticizer, 0.5-2 parts of the stabilizer, 0.5-5 parts of CPE, 0.5-5 parts of PEG and 0.5-15 parts of the absorbent.

### BACKGROUND OF THE INVENTION

(a) Technical Field of the Invention

This invention relates to a floor tile and relates particularly to a convenient floor tile.

(b) Description of the Prior Art

A stone plastic floor tile, also known as a stone plastic structured floor, the scientific name called PVC vinyl plank tile which is a high quality, a high technical, a new style decoration material for ground. The stone plastic floor tile use a natural marble powder constructed a high density and a high fiber and net structure of strong foundation. The surface covered a super wear-resisting macromolecule of PVC wear-resisting layer, the accomplishment of the process after hundreds of procedures are reached. The stone plastic floor has a beautiful and a realistic texture, which is strong and wear-resisting with shining surface, but it is not apt to slide.

For the convenience of enabling the stone plastic floor to re-stick on, the main structure comprises a convenient tiling layer, a base layer and a surface layer which are superimposed in sequence from bottom to top. The convenient tiling layer usually is a material of hot melt adhesive, and the base layer usually contains plasticizers. During the process of paving the tile, the base layer usually precipitates a plasticizer acting with the hot melt adhesive. Thus the consistency degree is increased, the re-stick function is not allowed to fulfill, which is inconvenient for usage. For preventing precipitation of the plasticizer, the method is to install an absorbing layer between the base layer and the convenient tiling layer presently. And use the absorbing layer isolating the plasticizer and the hot melt adhesive to restrict the reaction occurred, thereby a preferable function of the convenient floor tile is fulfilled. Nevertheless, the method causes the product's structure and production procedure complicated, and inconvenient to the mass production. Besides, the cost is higher which is disadvantageous to promote the economic effect.

### SUMMARY OF THE INVENTION

Accordingly, this invention is to improve defects of present technique. The object of this invention is to provide a convenient floor tile which present a convenient paving function, simple structure and production procedure with a lower cost.

For fulfilling the purpose as above mentioned, a technical program is adopted as follows:

A convenient floor tile in accordance with this invention comprises a convenient tiling layer, a base layer and a surface layer which are superimposed in sequence from bottom to top. A composition of the base layer includes PVC, a plasticizer, a stabilizer and an anti-precipitation agent. The anti-precipitation agent is made from CPE, PEG and an absorbent. The composition and material are calculated in parts by weight: 100 parts of PVC, 30-50 parts of the plasticizer, 0.5-2 parts of the stabilizer, 0.5-5 parts of CPE, 0.5-5 parts of PEG and 0.5-15 parts of the absorbent.

Preferably, the plasticizer is at least one of DINP and DOTP.

Preferably, the stabilizer is at least one of the calcium stearate and the zinc stearate.

Preferably, a grain size of the absorbent is at least 50 nm to 500 nm.

Preferably, the absorbent is at least one of the carbonate and the layered silicate and the oxide.

Preferably, the carbonate is the calcium carbonate, the layered silicate is an organic montmorillonite, the oxide is silicon dioxide.

Preferably, the convenient tiling layer is a hot melt adhesive.

The technical program of the convenient floor tile as above-mentioned comparing with present technique has an obvious advantage and beneficial effects. Concretely speaking, it is knowable from above-mentioned technical program as follows: By method of adding an anti-precipation agent, the hydroxyl at two ends of PEG and CPE can act with elements of PVC with greater electronegativity, such as chlorine and oxygen, and molecules of the plasticizer to produce a hydrogen bond or intermolecular forces. The intermolecular forces hold the PVC and the plasticizer to prevent the precipitation of the plasticizer, and the absorbent absorbs the molecules of the plasticizer to prevent the precipitation of the molecules. Thus, the convenient tiling layer does not react with the base layer. A preferable tiling function is attained without adding extra absorbing layers, thereby simplifying the structure and production procedures of the product and allowing a mass production, lower costs and a promoted economic effect.

The construction characteristics and effects of this invention will become more apparent upon reading the following descriptions in junction with the accompanying drawings.

### BRIEF DESCRIPTION OF THE DRAWINGS

FIG. 1 is a cross-sectional view showing a first preferred embodiment of this invention.

### DETAILED DESCRIPTION OF THE PREFERRED EMBODIMENTS

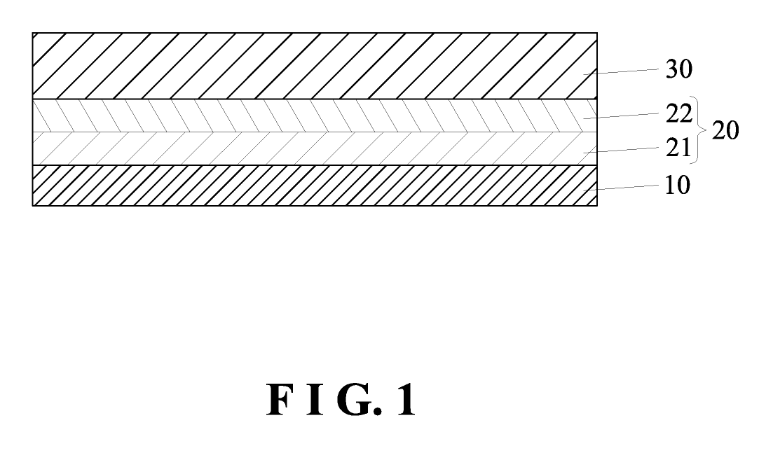

Referring to FIG. 1 show a first preferred embodiment of a convenient floor tile of this invention. The convenient floor tile comprises a convenient tiling layer 10, a base layer 20 and a surface layer 30.

The convenient tiling layer 10 is made from a hot melt adhesive, the convenient tiling layer 10, the base layer 20 and a surface layer 30 which are superimposed in sequence from bottom to top. A composition of the base layer includes PVC, a plasticizer, a stabilizer and an anti-precipitation agent. The anti-precipitation agent is made from CPE (Chlorinated Polyethlene), PEG (Polyethylene Glycol) and an absorbent. The composition and material are calculated in parts by weight: 100 parts of PVC, 30-50 parts of the plasticizer, 0.5-2 parts of the stabilizer, 0.5-5 parts of CPE, 0.5-5 parts of PEG and 0.5-15 parts of the absorbent. The plasticizer is at least one of the DINP (Diisononyl Phthalate) and DOTP (Dioctyl Terephthalate). The stabilizer is at least one of the calcium stearate and the zinc stearate. The hydroxyl at two ends of PEG and CPE can act with elements of PVC with greater electronegativity, such as chlorine and oxygen, and molecules of the plasticizer to produce a hydrogen bond or intermolecular forces. The intermolecular forces hold the PVC and the plasticizer to prevent the precipitation of the plasticizer, and the absorbent absorbs the molecules of the plasticizer to prevent the precipitation of the molecules. A grain size of the absorbent is 50 nm to 500 nm, the absorbent is at least one of carbonate and a layered silicate and an oxide, the carbonate is calcium carbonate, the layered silicate is an organic montmorillonite, the oxide is silicon dioxide.

When producing the anti-precipation agent, only have to mingle the CPE (Chlorinated Polyethlene), PEG (Polyethylene Glycol) and the absorbent well-mixed together. And when processing the material of the base layer 20, only have to add an anti-precipation agent to the PVC, the plasticizer and the stabilizer and mix evenly. The produce method of the material of the base layer 20 is a present technique, a description of the produce method is not provided in details. Once the material of the base layer 20 is finished, the material is available of using in producing a convenient floor tile. The concrete step of a convenient floor tile is a present technique, a description of the produce method is not provided in details.

The embodiments of this invention described as follows.

### Embodiment 1

The convenient tiling layer 10, the base layer 20 and the surface layer 30 which are superimposed in sequence from bottom to top. A composition of the base layer 20 includes PVC, a plasticizer, a stabilizer and an anti-precipitation agent. The anti-precipitation agent is made from CPE (Chlorinated Polyethlene), PEG (Polyethylene Glycol) and an absorbent. The composition and material are calculated in parts by weight: 100 parts of PVC, 30-50 parts of the plasticizer, 0.5-2 parts of the stabilizer, 0.5-5 parts of CPE, 0.5-5 parts of PEG and 0.5-15 parts of the absorbent. The plasticizer at least is one of the DINP (Diisononyl Phthalate) and DOTP (Dioctyl Terephthalate). The stabilizer at least is one of the calcium stearate and the zinc stearate. A grain size of an absorbent is at least 50 nm, an absorbent is carbonate and the carbonate is calcium carbonate.

### Embodiment 2

The convenient tiling layer 10, the base layer 20 and a surface layer 30 which are superimposed in sequence from bottom to top. A composition of the base layer 20 includes PVC, a plasticizer, a stabilizer and an anti-precipitation agent. The anti-precipitation agent is made from CPE (Chlorinated Polyethlene), PEG (Polyethylene Glycol) and an absorbent. The composition and material are calculated in parts by weight: 100 parts of PVC, 50 parts of the plasticizer, 1 part of the stabilizer, 1 part of CPE, 2 parts of PEG and 5 parts of the absorbent. The plasticizer is at least one of the DINP (Diisononyl Phthalate) and the DOTP (Dioctyl Terephthalate). The stabilizer is at least one of the calcium stearate and the zinc stearate. A grain size of an absorbent is at least 500 nm, an absorbent is a layered silicate and the layer silicate is an organic montmorillonite.

### Embodiment 3

The convenient tiling layer 10, the base layer 20 and a surface layer 30 which are superimposed in sequence from bottom to top. A composition of the base layer 20 includes PVC, a plasticizer, a stabilizer and an anti-precipitation agent. The anti-precipitation agent is made from CPE (Chlorinated Polyethlene), PEG (Polyethylene Glycol) and an absorbent. The composition and material are calculated in parts by weight: 100 parts of PVC, 32 parts of the plasticizer, 1.2 parts of the stabilizer, 2 parts of CPE, 1 part of PEG and 7 parts of the absorbent. The plasticizer is at least one of the DINP (Diisononyl Phthalate) and DOTP (Dioctyl Terephthalate). The stabilizer is at least one of the calcium stearate and the zinc stearate. A grain size of an absorbent is at least 100 nm, an absorbent is an oxide and the oxide is silicon dioxide.

### Embodiment 4

The convenient tiling layer 10, the base layer 20 and the surface layer 30 which are superimposed in sequence from bottom to top. A composition of the base layer 20 includes PVC, a plasticizer, a stabilizer and an anti-precipitation agent. The anti-precipitation agent is made from CPE (Chlorinated Polyethlene), PEG (Polyethylene Glycol) and an absorbent. The composition and material are calculated in parts by weight: 100 parts of PVC, 34 parts of the plasticizer, 1.3 parts of the stabilizer, 4 parts of CPE, 3 parts of PEG and 7 parts of the absorbent. The plasticizer is at least one of the DINP (Diisononyl Phthalate) and DOTP (Dioctyl Terephthalate). The stabilizer is at least one of the calcium stearate and the zinc stearate. A grain size of an absorbent is at least 200 nm, the absorbent is carbonate and a layered silicate, the carbonate is calcium carbonate, the layered silicate is an organic montmorillonite.

### Embodiment 5

The convenient tiling layer 10, the base layer 20 and the surface layer 30 which are superimposed in sequence from bottom to top. A composition of the base layer 20 includes PVC, a plasticizer, a stabilizer and an anti-precipitation agent. The anti-precipitation agent is made from CPE (Chlorinated Polyethlene), PEG (Polyethylene Glycol) and an absorbent. The composition and material are calculated in parts by weight: 100 parts of PVC, 37 parts of the plasticizer, 0.9 part of the stabilizer, 3 parts of CPE, 4 parts of PEG and 8 parts of the absorbent. The plasticizer is at least one of the DINP (Diisononyl Phthalate) and DOTP (Dioctyl Terephthalate). The stabilizer is at least one of calcium stearate and zinc stearate. A grain size of an absorbent is at least 300 nm, the absorbent is carbonate and an oxide, the carbonate is calcium carbonate, the oxide is silicon dioxide.

### Embodiment 6

The convenient tiling layer 10, the base layer 20 and the surface layer 30 which are superimposed in sequence from bottom to top. A composition of the base layer 20 includes PVC, a plasticizer, a stabilizer and an anti-precipitation agent. The anti-precipitation agent is made from CPE (Chlorinated Polyethlene), PEG (Polyethylene Glycol) and an absorbent. The composition and material are calculated in parts by weight: 100 parts of PVC, 41 parts of the plasticizer, 0.7 part of the stabilizer, 2.6 parts of CPE, 3.5 parts of PEG and 10 parts of the absorbent. The plasticizer is at least one of the DINP (Diisononyl Phthalate) and DOTP (Dioctyl Terephthalate). The stabilizer is at least one of calcium stearate and zinc stearate. A grain size of an absorbent is at least 400 nm, the absorbent is a layered silicate and an oxide, the layered silicate is an organic montmorillonite, the oxide is silicon dioxide.

### Embodiment 7

The convenient tiling layer 10, the base layer 20 and the surface layer 30 which are superimposed in sequence from bottom to top. A composition of the base layer 20 includes PVC, a plasticizer, a stabilizer and an anti-precipitation agent. The anti-precipitation agent is made from CPE (Chlorinated Polyethlene), PEG (Polyethylene Glycol) and an absorbent. The composition and material are calculated in parts by weight: 100 parts of PVC, 43 parts of the plasticizer, 1.6 parts of the stabilizer, 3.3 parts of CPE, 4.3 parts of PEG and 11 parts of the absorbent. The plasticizer is at least one of the DINP (Diisononyl Phthalate) and DOTP (Dioctyl Terephthalate). The stabilizer is at least one of calcium stearate and zinc stearate. A grain size of an absorbent is at least 250 nm, the absorbent is a layered silicate, the layered silicate is an organic montmorillonite.

### Embodiment 8

The convenient tiling layer 10, the base layer 20 and the surface layer 30 which are superimposed in sequence from bottom to top. A composition of the base layer 20 includes PVC, a plasticizer, a stabilizer and an anti-precipitation agent. The anti-precipitation agent is made from CPE (Chlorinated Polyethlene), PEG (Polyethylene Glycol) and an absorbent. The composition and material are calculated in parts by weight: 100 parts of PVC, 45 parts of the plasticizer, 1.8 parts of the stabilizer, 4.5 parts of CPE, 3.2 parts of PEG and 15 parts of the absorbent. The plasticizer is at least one of the DINP (Diisononyl Phthalate) and the DOTP (Dioctyl Terephthalate). The stabilizer is at least one of calcium stearate and zinc stearate. A grain size of an absorbent is at least 450 nm, the absorbent is composed of carbonate, a layered silicate and an oxide, the carbonate is calcium carbonate, the layered silicate is an organic montmorillonite, the oxide is silicon dioxide.

The anti-precipitation test proceeding in compliance with the standard of the GBT20499-2006 for each embodiment as above-mentioned of the convenient floor tile, the specific test results as the chart listed as follows:

| | Comparison | | | | |
|---|---|---|---|---|---|
| | | | | The Mobility of | |
| | | Initial | | Anti-Precipation | |
| | | Mobility(%) | | Agent added(%) | |
| | | Pure | 95 | Pure | 95% |
| | Content of | Water | Ethanol | Water | Ethanol |
| Embodiment | Plasticizer | 50 C. | 50 C. | 50 C. | 50 C. |
| 1 | DINP 30 | 0.05 | 5.5 | 0.028 | 2.4 |
| | DOTP 30 | 0.04 | 4.4 | 0.008 | 1.1 |
| 2 | DINP 50 | 0.06 | 5.6 | 0.03 | 2.5 |
| | DOTP 50 | 0.03 | 4.6 | 0.01 | 1.2 |
| 3 | DINP 32 | 0.05 | 5.3 | 0.02 | 2.4 |
| | DOTP 32 | 0.03 | 4.2 | 0.007 | 1.25 |
| 4 | DINP 34 | 0.047 | 5.5 | 0.028 | 2.6 |
| | DOTP 34 | 0.036 | 4.4 | 0.013 | 1.4 |
| 5 | DINP 37 | 0.065 | 5.7 | 0.029 | 2.4 |
| | DOTP 37 | 0.037 | 4.8 | 0.014 | 1.3 |
| 6 | DINP 41 | 0.07 | 5.8 | 0.03 | 2.6 |
| | DOTP 41 | 0.04 | 4.9 | 0.02 | 1.4 |
| 7 | DINP 43 | 0.064 | 5.6 | 0.022 | 2.5 |
| | DOTP 43 | 0.042 | 4.8 | 0.013 | 1.3 |
| 8 | DINP 45 | 0.055 | 5.4 | 0.025 | 2.4 |
| | DOTP 45 | 0.028 | 4.3 | 0.009 | 1.1 |

It is perceived from above chart that a process of adding an anti-precipation agent to a base layer 20 which lower the mobility largely and reach a great anti-precipation effect. Thus the convenient tiling layer 10 maintains its original character, a great character of convenience of the product is attained.

The important point of this invention consist in: By way of adding an anti-precipation agent, the hydroxyl at two ends of PEG and CPE can act with elements of PVC with greater electronegativity, such as chlorine and oxygen, and molecules of the plasticizer to produce a hydrogen bond or intermolecular forces. The intermolecular forces hold the PVC and the plasticizer to prevent the precipitation of the plasticizer, and the absorbent absorbs the molecules of the plasticizer to prevent the precipitation of the molecules. Thus, the convenient tiling layer does not react with the base layer. A preferable tiling function is attained without adding extra absorbing layers, thereby simplifying the structure and production procedures of the product and allowing a mass production, lower costs and a promoted economic effect.

While the embodiments of this invention are shown and described but not made to restrict the scope of this invention, it is understood that further variations and modifications may be made without departing from the scope of this invention.

I claim:

1. A convenient floor tile comprising a convenient tiling layer, a base layer and a surface layer which are superimposed in sequence from bottom to top; wherein a composition of said base layer includes PVC, a plasticizer, a stabilizer and an anti-precipitation agent, a material of said anti-precipitation agent being made from CPE, PEG and an absorbent, said composition and said material being calculated in parts by weight: 100 parts of said PVC, 30-50 parts of said plasticizer, 0.5-2 parts of said stabilizer, 0.5-5 parts of said CPE, 0.5-5 parts of said PEG and 0.5-15 parts of said absorbent.

2. The convenient floor tile as claimed in claim 1, wherein said plasticizer is at least one of DINP and DOTP.

3. The convenient floor tile as claimed in claim 1, wherein said stabilizer is at least one of calcium stearate and zinc stearate.

4. The convenient floor tile as claimed in claim 1, wherein a grain size of said absorbent is 50 nm to 500 nm.

5. The convenient floor tile as claimed in claim 1, wherein said absorbent is at least one of carbonate, a layered silicate and an oxide.

6. The convenient floor tile as claimed in claim 5, wherein said carbonate is calcium carbonate, said layered silicate is an organic montmorillonite, and said oxide is silicon dioxide.

7. The convenient floor tile as claimed in claim 1, wherein said convenient tiling layer is a hot melt adhesive.
